(19) United States
(12) Patent Application Publication
(10) Pub. No.: US 2007/0175868 A1
(43) Pub. Date: Aug. 2, 2007

(54) SINGLE DRIVE AND SOURCE FOR ADJACENTLY CLAMPING AND RESISTANCE WELDING

(75) Inventors: Tommy Christensen, Vanersborg (SE); Pei-Chung Wang, Troy, MI (US); Scott E. Deal, Warren, MI (US); Thomas Lilja, Trollhattan (SE); Peter Bogren, Vallda (SE)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/614,288

(22) Filed: Dec. 21, 2006

Related U.S. Application Data
(63) Continuation-in-part of application No. 11/178,171, filed on Jul. 8, 2005.

(51) Int. Cl. B23K 11/10

(52) U.S. Cl. 219/86.25

(57) ABSTRACT

A resistance spot welding system (10) for sequentially clamping a plurality of workpieces (20,22) at predetermined locations and welding the workpieces (20,22) substantially adjacent the locations, including a clamping element (24) able to be locked in a workpiece engaged position, at least one set of equalizing welding electrodes (28,30) for oppositely engaging the workpieces (20,22) so as to produce the weld (12) without deformation, a singular drive mechanism (14) including a cam coupled to the clamping element (24) and electrodes (28,30), and a singular source (16) for actuating the mechanism (14) and generating the welding and clamping forces.

### CROSS-REFERENCES TO RELATED APPLICATIONS

This U.S. Non-Provisional patent application is a continuation-in-part and claims the benefit of pending U.S. Non-Provisional Ser. No. 11/178,171 filed on Jul. 8, 2005, entitled SYSTEM AND METHOD FOR CLAMPING AND RESISTANCE WELDING (hereinafter the 171 application), incorporated by reference herein.

### BACKGROUND OF THE INVENTION

1. Technical Field

The present invention relates to resistance spot welding systems and methods and more particularly to an improved resistance spot welding system having a single drive and source for clamping a plurality of workpieces at a first location and welding the workpieces substantially adjacent the first location.

2. Discussion of Prior Art

Resistance spot welding systems are used in various industrial applications, including automotive vehicle body construction. These systems function to apply pressure to and transmit an electric current through a plurality of adjacently secured workpieces, such that the resistance of the workpieces generates sufficient heat energy to produce a spot weld therebetween. The assembly is initially secured by first positioning the workpieces in a desired configuration, and then using fixtures to clamp the workpieces together. A typical fixture consists of various types of tooling elements that accurately locate and orient the workpieces with respect to the tool path and restrains workpiece motion in the presence of welding electrode forces.

In most systems, part positioning, clamping and welding are performed by a plurality of programmable robots, each having its own drive mechanism, control, and actuation source, within an assembly cell. For example, a first set of robots may be used for handling and clamping the workpieces at predetermined datum locations, while a separate set of robots are used to weld the workpieces to initially produce a plurality of dimension control welds (DCWs). The datum locations are verified during the construction and installation of the assembly cell, and the DCWs are typically produced as close to the datum locations as possible to minimize workpiece deformation. Due to equipment size and configuration (e.g., robotic bulk), however, the electrodes are typically unable to produce these welds near or substantially adjacent the datum location, and must therefore engage the workpieces at locations spaced a minimum distance from the datum locations. Applying compressive welding forces at these non-datum locations results in workpiece deformation that reduces dimensional accuracy.

To alleviate this concern extended weld gun arms, which do not interfere with the clamping units, have been increasingly incorporated. However, the longer arms have resulted in an increase in the total size of the gun unit, as the required input force has correspondingly increased. These multi-robotic systems further present various manufacturing concerns, including overcrowding of floor and three-dimensional space within the assembly cell, increased tooling costs, and longer cycle times. While the foremost concern directly impacts operator convenience and efficiency, the later concerns affect overall costs of production. Finally, as processes and product designs become increasingly complex these concerns intensify.

In response to these further concerns, the 171 application discloses the general concept of a spot welding system for clamping a plurality of workpieces at and welding the workpieces substantially adjacent predetermined datum locations. The preferred embodiments of the system disclosed therein present concentrically alignable clamping and welding elements during engagement that are configured to produce an annular weld about the datum location. However, while substantially reducing the distance between the weld and datum location, the system disclosed by the 171 application presents a complex structural and mechanical configuration that is difficult to implement.

Accordingly, there remains a need in the art for an improved system and method for spot welding a plurality of workpieces substantially adjacent datum locations, so as to reduce workpiece deformation, that can also be efficiently implemented.

### BRIEF SUMMARY OF THE INVENTION

Responsive to these and other concerns, the present invention presents a resistance spot welding system for reducing workpiece deformation that presents a simplified structural and mechanical configuration. Among other things, the present invention is useful for reducing assembly cell congestion by combining the separate drive mechanisms and actuation sources of conventional weld and clamp units into a single drive mechanism and source. Further, the present invention is useful for allowing the weld unit to compensate for electrode wear by enabling weld gun equalization.

A first aspect of the present invention broadly concerns a system for clamping and welding a plurality of workpieces. The system includes a clamp configured to engage the workpieces by applying a clamping force at a first location, so as to retain the workpieces in a relatively fixed condition. The system further includes an electrode positioned and configured to engage by applying a welding force to and passing an electric current through a section of the workpieces, wherein said section is substantially adjacent the first location. A drive mechanism is drivenly coupled to the clamp and electrode, and configured to cause the clamp and electrode to engage the workpieces when actuated. Finally, the inventive system includes a source configured to produce the clamping and welding forces, and actuate the mechanism, so as to transfer the forces through the mechanism to the clamp and electrode.

A second aspect of the present invention concerns a method of clamping and welding a plurality of workpieces in a predetermined assembly configuration and reducing assembly cell congestion, wherein at least one datum location for clamping the workpieces is predetermined, so as to minimize deformation during clamping and welding. The method further includes the steps of fixing the workpieces in the assembly configuration, and securing a clamping and welding system having a single drive mechanism in relation to the workpieces. The workpieces at the datum location are then engaged by actuating the drive mechanism of the system, so as to clamp and retain the workpieces in the assembly configuration. Finally, an electric current is applied through and pressure is applied to the workpieces at a second location substantially adjacent the first location also by the actuation of the drive mechanism.

It will be understood and appreciated that the present invention provides a number of advantages over the prior art, including, for example, providing localized impression of the workpieces by clamping and subsequently joining the workpieces in a substantially adjacent configuration. Since a single power source and drive mechanism is utilized, the system is more compact, which enables a higher density of weld units, a reduction in the needed number of station fixtures, and increased access for maintenance. The single power source also eliminates the need for separate controls for clamping and welding (i.e., additional control logic, separate valves in cases where a pneumatic drive is utilized, and separate electrical control in cases where an electrical drive is utilized). Thus, the number of robots needed is reduced, further resulting in increased floor space, a reduction in complexity, cycle time, and the need for manpower or hours-per-vehicle (HPV).

Other aspects and advantages of the present invention will be apparent from the following detailed description of the preferred embodiment(s) and the accompanying drawing figures.

### BRIEF DESCRIPTION OF THE SEVERAL VIEWS OF THE DRAWING

Preferred embodiments of the invention are described in detail below with reference to the attached drawing figures, wherein:

FIG. 1 is a perspective view of a clamping and resistance spot welding system in accordance with a preferred embodiment of the present invention, and two workpieces being clamped and welded by the system;

FIG. 1a is a perspective view of a plurality of two workpieces, particularly illustrating exemplary datum locations;

FIG. 2 is a perspective view of a resistance spot welding system without the clamping element in accordance with a preferred embodiment of the present invention;

FIG. 3 is a perspective view of a resistance spot welding system with the clamping element and two sets of electrodes, in accordance with a preferred embodiment of the present invention;

FIG. 4 is an exploded view of a clamping and welding system in accordance with a preferred embodiment of the present invention, particularly illustrating a clamp swing arm, weld swing arm, linearly translating drive mechanism, lower weld arm/connecting plate, and fixed housing structure;

FIG. 5 is a left elevation view of the simplified mechanical configuration of a resistance spot welding system in accordance with a preferred embodiment of the present invention, particularly illustrating an upper weld swing arm, drive mechanism, connecting plate, fixed housing structure, and two workpieces;

FIG. 5a is a front elevation view of the system shown in FIG. 5;

FIG. 5b is a right elevation view of the system shown in FIG. 5;

FIG. 6 is a left elevation view of the system shown in FIG. 5, particularly illustrating upper and lower weld arms in initial disengaged positions, a plurality of workpieces, and station fixture;

FIG. 6a is a left elevation view of the system shown in FIG. 6, particularly illustrating the upper weld swing arm in the workpiece engaged position, and the lower weld arm in a disengaged position;

FIG. 6b is a left elevation view of the system shown in FIG. 6, particularly illustrating the upper weld swing arm in the workpiece engaged position, and the lower weld arm in an engaged position;

FIG. 7 is an elevation view of the upper clamp and weld swing arms shown in FIG. 4, in the initial disengaged position, particularly illustrating the shared axis of rotation, arm engaging pin (bearing), and the slot openings;

FIG. 7a is an elevation view of the upper clamp and weld swing arms shown in FIG. 7, in an intermediate disengaged position wherein the clamp arm precedes the weld arm;

FIG. 7b is an elevation view of the upper clamp and weld swing arms shown in FIG. 7, wherein the clamp arm is in the workpiece engaged position and the weld arm trails in an intermediate position;

FIG. 7c is an elevation view of the upper clamp and weld swing arms shown in FIG. 7, wherein both arms are in the workpiece engaged position;

FIG. 7d is an elevation view of the upper clamp and weld swing arms shown in FIG. 7, wherein the weld arm is in an overrated position; and

FIG. 8 is a table of theoretical welding forces applied to the workpieces by the system for a plurality of given source force, welding shank length, and cylinder diameter combinations.

### DETAILED DESCRIPTION OF THE INVENTION

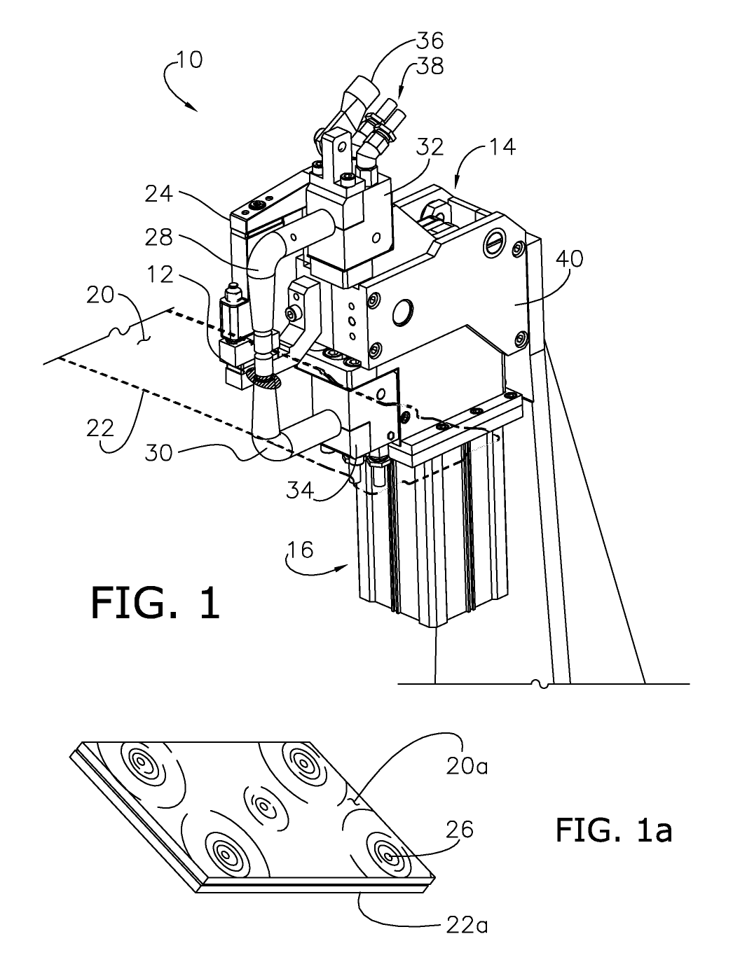

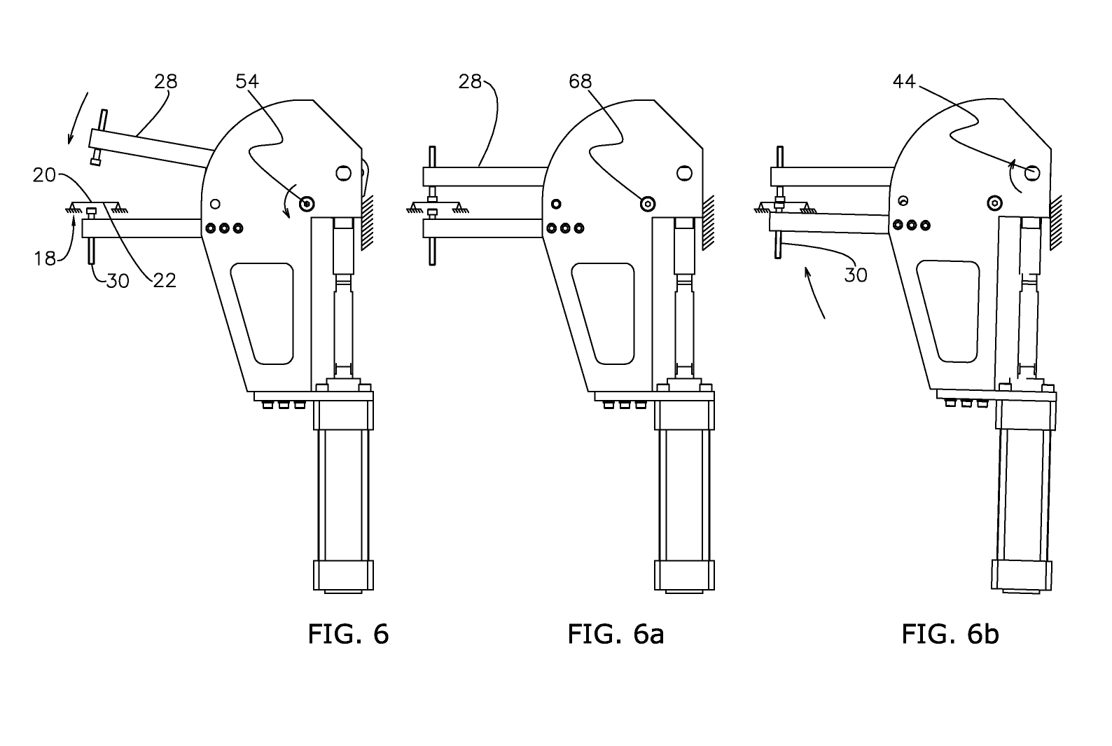

As best shown in FIG. 1, the present invention concerns an improved resistance welding system 10 for clamping and welding a plurality of workpieces, such as the component parts of a body-panel or support roof assembly of an automobile, to produce a spot or seam weld 12. The inventive system 10 includes a single drive mechanism 14 and a single combined clamping and welding force generating source 16. The system 10 is intended for use within an assembly station, wherein the workpieces are first placed upon station fixture 18 (FIG. 6) by a human or robotic operator (not shown). The preferred system 10 is robotically maneuverable into position along multi-axes, configured to receive sensory input, and is programmably controlled. Although described and illustrated herein with respect to spot welding, it is appreciated that the inventive aspects of the system 10 may be utilized with other compressive joining means, such as weldbonding, riveting, rivetbonding, clinching, clinchbonding, or wherever it is desired to reduce workpiece deformation by joining the workpieces substantially adjacent the clamping location.

As shown in FIGS. 1 and 1a, a plurality of two workpieces 20,22 of equal thickness is preferably welded; however, the system 10 may be utilized to weld a greater plurality or structural components having variable thickness. The workpieces 20,22 may be formed of a wide range of materials including steel, iron alloys, aluminum alloys, magnesium alloys, titanium and molybdenum, and present thicknesses of variable dimension. However, operable thickness and workpiece dimensioning/welding location are limited by the capabilities of the system 10 as further described herein. Finally, the workpieces 20,22 present oppositely engagable upper and lower surfaces 20a,22a, wherein the surfaces 20a,22a are preferably parallel (FIG. 1a).

Turning to the configuration of the system 10, the system 10 generally includes a clamping element (or “clamp”) 24 for engaging the workpieces 20,22 at a first location or imprint, so as to secure the workpieces 20,22 in a fixed relative condition (FIG. 1). More preferably, the clamping imprint is centered at a datum point 26 (FIG. 1a) determined by suitable methodology, such as a conventional finite analysis method. It is appreciated by those ordinarily skilled in the art that at these points clamping force is optimized and workpiece deformation due to clamping is minimized. A plurality of datum points 26 is typically determined in combination, so as to counterbalance each other.

At least one welding electrode 28 is configured to produce the weld 12 substantially adjacent the first location, wherein the term “substantially adjacent” shall mean within 5 cm, and more preferably, within 2 cm of the imprint. As best shown in FIGS. 1 through 3, the system 10 further includes virtually identical backup (or “second”) electrodes 30 that engage the workpieces 20,22 opposite the welding electrode 28 to complete the electric potential. The preferred electrodes 28,30 each present a tubular configuration, and are coaxially aligned in a workpiece engaged position (FIGS. 1, 5 and 6b). More preferably, the electrodes 28,30 each present a tapered welding cap and bent shank configuration as is conventionally utilized.

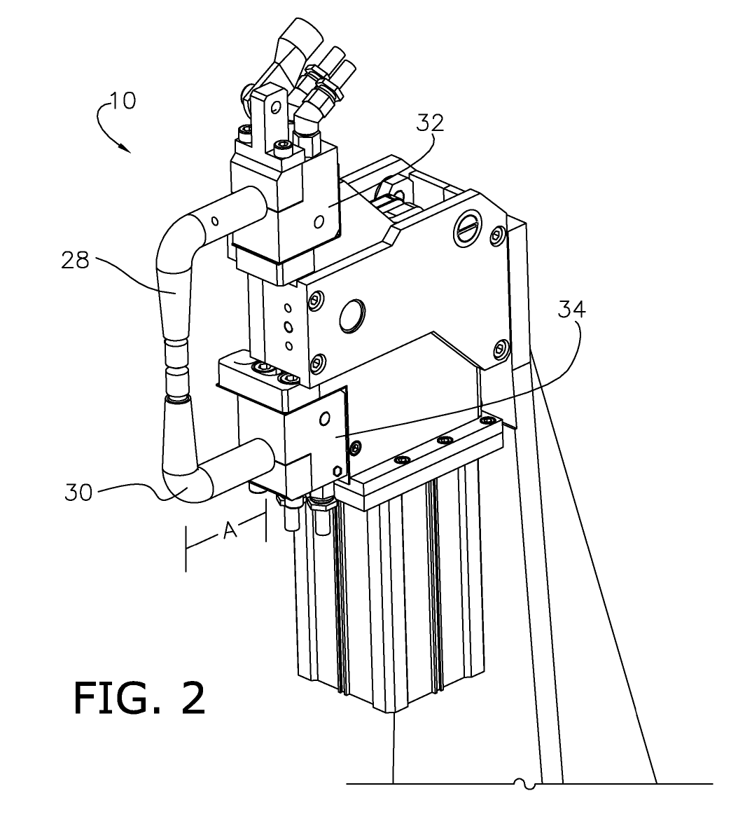

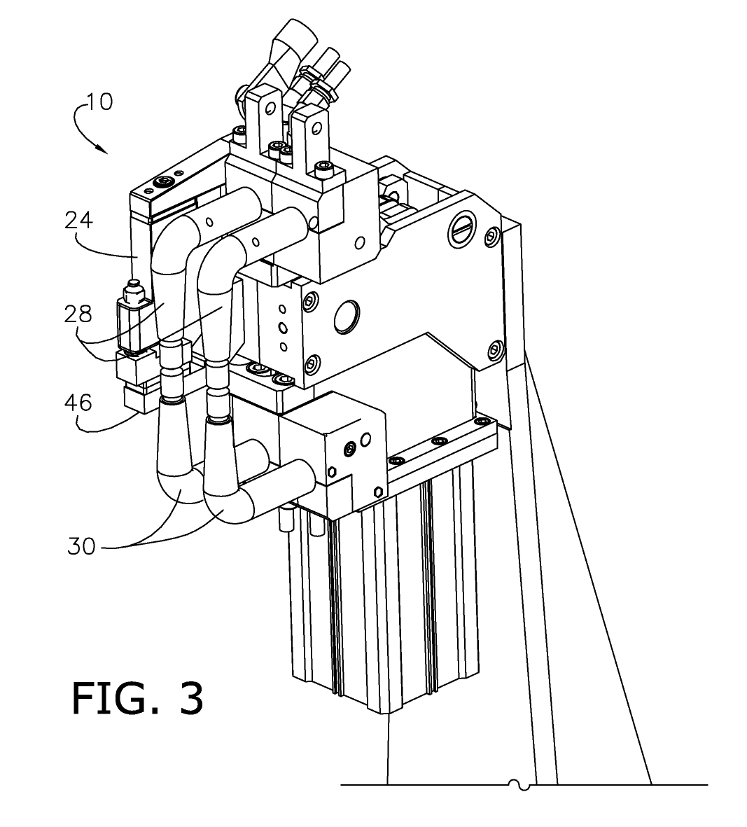

As shown in FIG. 2, the system 10 may be operated without the clamping element 24, and as such the preferred clamp 24 is removably connected (i.e., easily disconnected and reconnected manually by an operator) to the mechanism 14. The welding function and configuration of the system 10 further present novel and useful structural features and mechanical operation as further described herein. More preferably, the system 10 is configured so as to interchangeably interconnect and utilize one of a plurality of differing clamps 24 and electrode sets depending upon application. With respect to the latter, an electrode holder 32, which facilitates interconnection, supplies power to and secures the shank of the electrode 28, is preferably included. Likewise, a second electrode holder 34 is provided for the backing electrode 30. As shown in FIG. 3, the electrode holders 32,34 are preferably configured to concurrently secure more than one set of electrodes 28,30, where multiple concurrent spot welding is desired.

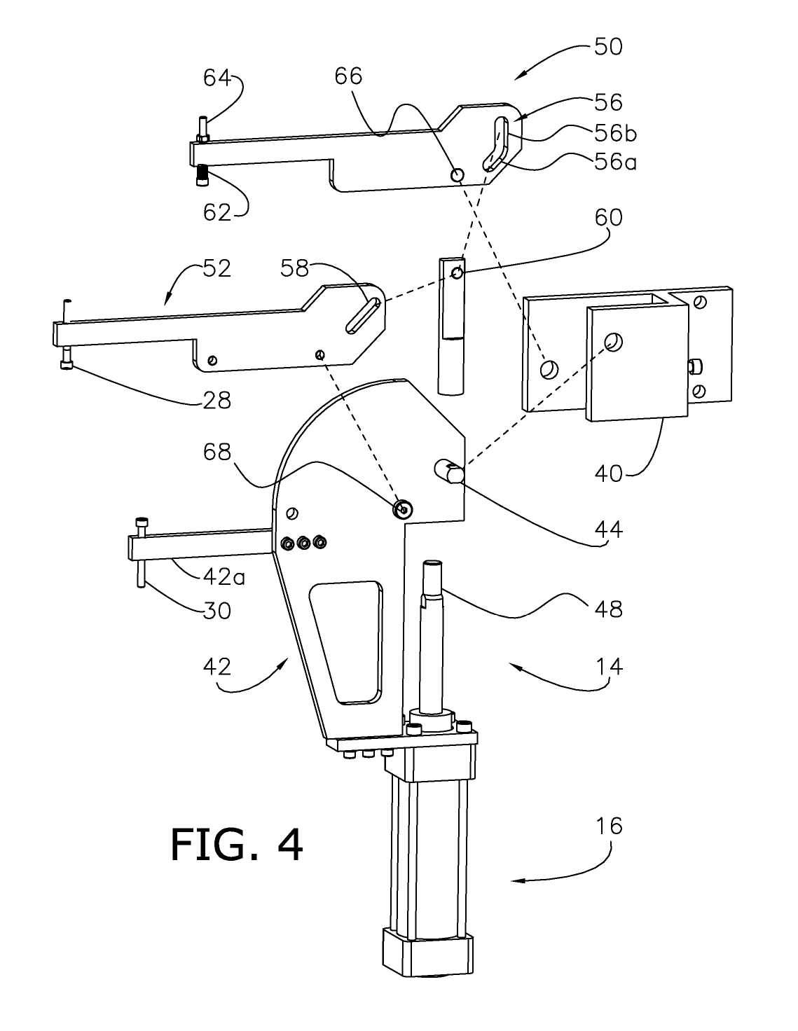

Returning to FIG. 1, the system 10 also includes appropriate appurtenances such as a welding cable connector 36 for connecting to and feeding electric potential to the welding electrode 28, and coolant ingress/egress nozzles 38 for receiving fresh, and removing heated, coolant. The mechanism 14, source 16, clamp 24, and welding electrodes 28,30 are coupled to a fixed housing structure 40 that maintains the system 10 in an operable position relative to the workpieces 20,22, provides leverage to the drive mechanism 14, and prevents motion in one direction. In the illustrated embodiment shown in FIGS. 4 through 6b, a connecting plate 42 interconnects the backing electrode 30, a lower weld arm 42a, the mechanism 14, and more preferably the source 16, as shown in FIG. 4. The plate 42 presents a connecting plate prong 44 for further providing rotational connection to the fixed housing structure 40.

More particularly, the preferred clamp 24 is configured to engage by applying a clamping force to a section of the workpieces 20,22 at a datum point 26, and is drivenly coupled to the drive mechanism 14 and source 16. A fixed backing block 46 (FIG. 3) may be included in the system 10 and configured to oppositely support the workpieces 20,22 relative to the clamp 24, or the station fixture 18 may be configured to provide the necessary counter force to the clamping element 24 (FIGS. 6-6b). The preferred electrodes 28,30 are configured to engage by applying a welding force to and passing an electric current through the workpieces 20,22 at opposite positions substantially adjacent the clamping location, and are also drivenly coupled to the mechanism 14 and source 16. Due to its close proximity to the conductive electrode 28 as well as to heat generated during welding, the preferred clamp 24 includes an insulated outer cover, and more preferably, is entirely formed of a non-conductive heat resistant material.

The source 16 is configured to produce the clamping and welding forces, and actuate the mechanism 14, so as to transfer the forces through the mechanism 14 and to the clamp 24 and electrodes 28,30. Among other technologies, the source 16 may be pneumatic, hydraulic, or electromechanical in operation. In the illustrated embodiment, the source 16 is interconnected to the drive mechanism 14, so as to cause a linearly translatable member 48 (FIG. 4) to move along a single longitudinal axis of freedom, wherein it is appreciated that a reversal of pneumatic pressure, for example, causes the member 48 to translate in the opposite direction to disengage the workpieces 20,22. It is understood that a single force is produced and applied both to the clamp 24 and electrodes 28,30, so as to derive the clamping and welding forces as shared.

The source 16 is preferably configured to result in a clamping force of approximately 50 kilogram force/per square centimeter (kgf/cm²) and a welding force of approximately 400 kgf/cm² being produced. Alternatively, the power source 16 is replaceable depending upon the application. For example, a larger power source may be utilized to drive longer weld arms or weld thicker workpieces. As presented in FIG. 8, it is appreciated that the provision of standard factory 6.12 kgf/cm² (i.e., 6 bar) or 10.2 kgf/cm² (i.e., 10 bar) air pressure as the source 16 and a pneumatic cylinder diameter size between 80 to 100 mm results in sufficient welding force being applied to the workpieces 20,22 for most electrode shank lengths, A (FIG. 2), and applications. It is appreciated, however, that the tabulated forces in FIG. 8 represent the maximum generated force for the combination, and that for a given application only a fraction of the maximum force may be required. As such, the preferred system 10 further includes a force reduction element (not shown), such as a pressure regulator where a pneumatic source 16 is utilized, that reduces the force to the required amount.

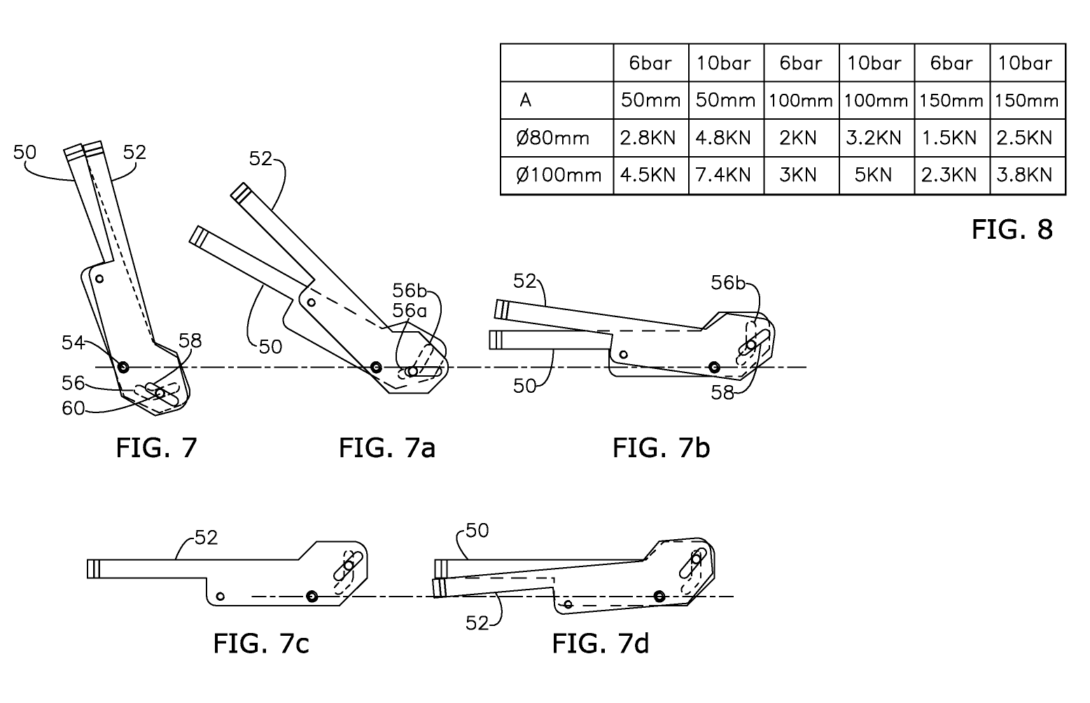

The mechanism 14, clamp 24 and electrodes 28,30 are cooperatively configured such that the clamp 24 engages the workpieces 20,22 prior to the electrodes 28,30. In the illustrated embodiment, the clamp 24 includes an upper clamp swing arm 50 (FIG. 4), the first electrode 28 is connected to an upper weld swing arm 52. The swing arms 50,52 preferably share an axis of rotation 54 as shown in FIGS. 7a-d, so that the arms 50,52 are rotatable between an initial disengaged position (FIG. 7) and a workpiece engaged position (FIG. 7c). To facilitate placement of workpieces 20,22 upon station fixture 18, the vertical space above the fixture 18 is unobstructed when the system 10 is in place by providing an initial disengaged position that forms at least a 70 degree angle with horizontal.

The mechanism 14 and swing arms 50,52 are cooperatively configured such that the arms 50,52 are caused to rotate from the initial disengaged position to the engaged position non-coextensively (i.e., either at different rates, or at the same rate but including a delay period for the welding swing arm 50), so that the clamp arm 50 reaches the engaged position first. More preferably, the clamp arm 50 is caused to reach the engaged position when the weld arm forms at least a 15 degree angle from the engaged position (FIG. 7b). To effect this motion, the arms 50,52 and mechanism 14 are exemplarily configured so as to cooperatively form a cam.

More particularly, as best shown in FIG. 4, the clamp arm 50 defines a clamp arm slot 56 preferably near the end opposite from the workpiece engaging end, so as to minimize the required linear translation of the member 48. The clamp slot 56 presents a bent longitudinal opening having a constant width. The longitudinal axis of a first section 56a of the clamp slot opening 56 presents a first pitch, P₁, as measured relative to and when the arm 50 is horizontal, while an adjacent upper section 56b presents a vertical longitudinal axis in the same arm position. The upper weld swing arm 52 defines a weld arm slot 58 preferably near the end opposite from the workpiece engaging end. The weld arm slot 58 preferably presents a straight longitudinal configuration, the same constant width as slot 56, and a second pitch, P₂, wherein P₂ is not less than (i.e., equal to or steeper than) P₁, but less than vertical in the horizontal arm position.

At least one laterally extending swing arm engaging pin (or cam follower) 60 is fixedly connected to the upper end of the linearly translating member 48, so as to be linearly translated therewith and slidingly engagable. More preferably, at least a portion of the pin 60 is rotatably coupled to the member 48, so as to present a bearing that is rollingly engagable. The pin 60 defines a cross-sectional diameter slightly less than (e.g., 95-99% of ) the widths of the slot openings 50,52, so as to be receivable by the slots 50,52 without intolerable lateral freedom. That is to say, the pin 60 once received and slots 50,52 are cooperatively configured such that the pin 60 is generally able to translate only along the longitudinal axis. Because the arms 50,52 are translatably fixed at their shared axis of rotation, the linear translation of the pin 60 when received by the slots 50,52 causes the arms to rotate at rates according to the current pitch of the section of the slot engaging the pin 60, wherein the steeper the slot the less rotational displacement is caused.

FIGS. 7 through 7d illustrate the translation of the pin 60 relative to slots 50,52 and the resulting rotational displacement of the arms 50,52. In FIG. 7 the arms 50,52 are at an initial disengaged position and the member 48 and pin 60 are preferably at their lowest point of translation. The pin 60 in this position engages the horizontally vertical section 56b of the clamp slot 56, which is presenting a current pitch less than slot 58. As the pin 60 translates upward due to the application of the source 16, the clamp arm 50 is caused to rotate faster than the weld arm 52 due to the difference in pitch. FIG. 7a shows the arms 50,52 in an intermediate position, wherein the welding arm slot 58 is horizontal thereby resulting in the greatest moment about the axis 48 being experienced. The pin 60 now engages the first section 56a of the clamp slot 56, so as to maintain an acceptable rate of rotation.

FIG. 7b shows the clamp arm 50 in the workpiece engaged position, and the welding arm 52 trailing in a second intermediary position. In this position the pin 60 begins to travel up the now vertical section 56b of the clamp slot 56 thereby causing no rotational displacement by the clamp arm 50. Thus, during operation the mechanism 14 is drivenly coupled to the clamp arm 50 only until the clamp 24 engages the workpieces 20,22 or shortly thereafter. Concurrently, the pin 60 continues to engage the weld arm 52 as the weld arm slot 58 remains diagonally oriented. Since the pin 60, which continues to be driven upward by the source 16, prevents the clamp arm 50 from rotating counter-directionally about the axis 48, the clamp arm 50 is “locked” in the engaged position. When the upward force vector no longer acts upon the clamp arm 50 (i.e., when the slot is vertical and has not been fully traveled), the preferred clamp 24 is further configured to generate the clamping force on its own. To that end, in the illustrated embodiment, a compression spring 62 is included, as best shown in FIG. 4. More particularly, at the workpiece engaging end of the clamp arm 50, the clamp 24 includes a plunger 64 that is telescopingly coupled to the spring 62 and clamp arm 50. The plunger 64 is configured to strike the upper surface 18a of the workpieces 20,22 as the clamp arm 50 rotates, thereby compressing the spring 62 until the clamp arm 50 reaches its locked position.

FIG. 7c shows the upper weld arm 52 in the workpiece engaged position, though the weld arm slot 52 remains diagonally oriented. As such, the pin 60, mechanism 14 and source 16 are able to gradually increase the applied force to operable welding amounts, as they attempt to further rotate the weld arm 52. The clamp arm 50 remains locked. As shown in FIG. 7d, the slot opening 58 and mechanism 14 are cooperatively configured to further allow the weld arm 52 to rotate past the engaged position where necessary (e.g., when the electrode tip is worn or tip-dressed). More particularly, the member 48 is able to be further upwardly translated past its point when the weld arm 52 is in the engaged position and the weld slot 58 presents a sufficient longitudinal length to allow further pin translation. Likewise, the vertical section 56b of the clamp slot 56 is also extended to accommodate. It is appreciated that this capability will allow system usage even where electrode wear and or misalignment has occurred.

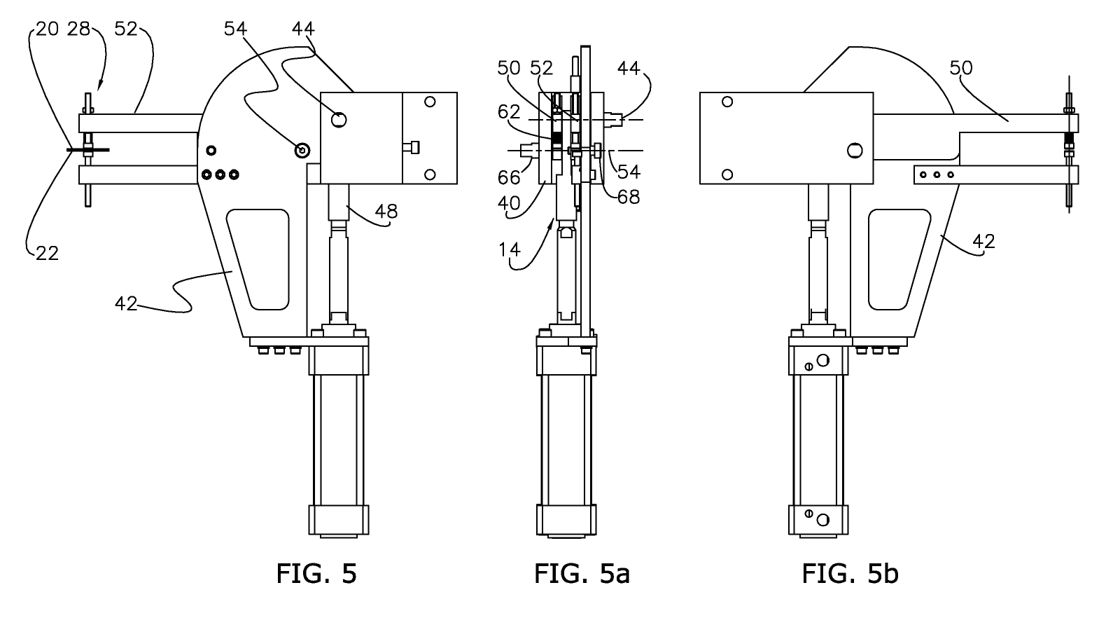

In another inventive aspect of the illustrated embodiment, it is also appreciated that the electrode 28 upon engaging the upper surface 20a of the workpieces 20,22, the upper weld arm 52, workpieces 20,22, mechanism 14 and source 16 are cooperatively configured to cause the backing electrode 30 to tilt upwards and engage the workpieces 20,22 by providing a degree of rotation about the connecting plate prong 44 (FIG. 6b). The ability to tilt upwards at least 3 degrees (i.e., “equalization”) enables the welding force to be applied to the workpieces 20,22 by both electrodes 28,30, so as to accommodate lower electrode tip-wear, miss-assembly and/or workpiece surface tolerancing; otherwise, where the backing electrode 30 is spaced from the lower workpiece surface 22a, the workpieces 20,22 must be deformed in order for the upper electrode 28 to reach the backing electrode 30. More particularly, to enable the concurrent application of the clamping force and equilization during welding, the axis of rotation 54 preferably shared by the arms 50,52 is defined by separate clamp arm and weld unit engaging bearings 66,68 (FIGS. 4 and 5a). That is to say, the separate bearings 66,68 enable the weld unit to rotate while the clamp arm 50 remains motionless. Finally, the pin 60 and prong 44 are minimally spaced, and more preferably aligned, when the electrode 28 is in the engaged position (FIGS. 5b and 7c) so as to minimize the force acting upon the clamp arm 50 during equilization.

The preferred forms of the invention described above are to be used as illustration only, and should not be utilized in a limiting sense in interpreting the scope of the present invention. Obvious modifications to the exemplary embodiments and modes of operation, as set forth herein, could be readily made by those skilled in the art without departing from the spirit of the present invention. For example, it is well within the ambit of the present invention to modify the cam configuration of the system 10 by utilizing the linear member 48 of the drive mechanism 14 to define the slots 56,58 and providing the pins or cam followers 60 on the arms 50,52 themselves.

The inventors hereby state their intent to rely on the Doctrine of Equivalents to assess the scope of the present invention as pertains to any apparatus, system or method not materially departing from the literal scope of the invention set forth in the following claims.

What is claimed is:

1. A system for clamping and resistance spot welding a plurality of workpieces, said system comprising:
a clamp configured to engage the workpieces by applying a clamping force at a first location and retain the workpieces in a relatively fixed condition;
a first electrode positioned and configured to engage by applying a welding force to and passing an electric current through a section of the workpieces, wherein said section is substantially adjacent the first location;
a drive mechanism drivenly coupled to the clamp and electrode, so as to cause the clamp and electrode to engage the workpieces when actuated; and
a source configured to produce the clamping and welding forces, and actuate the mechanism, so as to transfer the forces through the mechanism and to the clamp and electrode.

2. The system as claimed in claim 1, further comprising:
a second electrode positioned and configured to engage the section of the workpieces by contacting the workpieces opposite the first electrode,
said mechanism being drivenly coupled to the second electrode and configured to cause the second electrode to engage the workpieces.

3. The system as claimed in claim 1, wherein the mechanism is drivenly coupled to the clamp only until the clamp engages the workpieces, the clamp is locked in the workpiece engaged position, the clamp includes a compression spring, and the clamping force is cooperatively produced by the spring and source to retain the workpieces in the fixed condition after the clamp is locked in the engaged position.

4. The system as claimed in claim 1, wherein the source is configured to produce a maximum clamping force of approximately 50 kgf/cm² and welding force of approximately 400 kgf/cm².

5. The system as claimed in claim 1,
said first location being generally at a predetermined datum location.

6. The system as claimed in claim 1, further comprising:
a second electrode positioned and configured to engage by applying the welding force to and passing an electric current through a second section of the workpieces, wherein said second section is substantially adjacent the first location,
said mechanism and source being drivenly coupled to the second electrode and configured to cause the second electrode to engage the workpieces.

7. The system as claimed in claim 1, wherein the mechanism, clamp and electrode are cooperatively configured such that the clamp engages the workpieces prior to the electrode engages the workpieces.

8. The system as claimed in claim 1, wherein the clamp is removably connected to the mechanism, and the mechanism is inter-connectable with each of a plurality of removable clamps.

9. The system as claimed in claim 1, wherein the clamp is connected to a clamp swing arm, the electrode is connected to a weld swing arm, and the swing arms share an axis of rotation and are concurrently rotatable between an initial disengaged position and a workpiece engaged position.

10. The system as claimed in claim 9, wherein the axis of rotation, initial disengaged position and workpiece engaged position cooperatively define at least a 70 degree angle.

11. The system as claimed in claim 9, further comprising:
a second electrode positioned and configured to engage the section of the workpieces by contacting the workpieces opposite the first electrode,
said first electrode, workpieces and mechanism being cooperatively configured to cause the second electrode to tilt towards and engage the workpieces, when the first electrode is in the engaged position.

12. The system as claimed in claim 11, further comprising:
a fixed housing structure defining a prong receiving opening; and
a connecting plate configured to interconnect the second electrode, source, and mechanism, and having a prong insertable within the prong receiving opening, so that the plate, second electrode, source and mechanism are rotatably coupled to the fixed housing structure,
said first electrode, plate, source, workpieces and mechanism being cooperatively configured to cause the second electrode to tilt towards and engage the workpieces, when the first electrode is in the engaged position.

13. The system as claimed in claim 9, wherein the mechanism and swing arms are cooperatively configured such that the arms are caused to rotate from the initial disengaged position to the engaged position non-coextensively, so that the arms reach the workpiece engaged position non-concurrently.

14. The system as claimed in claim 13, wherein the mechanism, swing arms and clamp are cooperatively configured such that the clamp engages the workpieces when the weld swing arm forms a 15 degree angle from the engaged position.

15. The system as claimed in claim 13, wherein the mechanism and arms cooperatively present a cam configuration.

16. The system as claimed in claim 15, wherein the mechanism includes a linearly translatable member fixedly connected to a laterally extending swing arm engaging pin, each of said swing arms define a slot opening configured to receive the pin and defining a longitudinal slot axis, the pin and openings are cooperatively configured such that the pin is able to translate only along the longitudinal axis, and the slot opening defined by the clamp swing arm presents a different pitch relative to the slot opening defined by the weld swing arm.

17. The system as claimed in claim 16, wherein the pin and prong are minimally spaced when the first electrode is in the engaged position.

18. The system as claimed in claim 16, wherein the slot openings and mechanism are cooperatively configured to further allow the weld swing arm to rotate past the engaged position.

19. A system for clamping and resistance spot welding a plurality of workpieces, said system comprising:
a clamp configured to engage the workpieces by applying a clamping force at a first location and retain the workpieces in a relatively fixed condition;
a first electrode positioned and configured to engage by applying a welding force to and passing an electric current through a section of the workpieces, wherein said section is substantially adjacent the first location;
a drive mechanism drivenly coupled to the clamp and electrode, so as to cause the clamp and electrode to engage the workpieces when actuated; and
a source configured to produce the clamping and welding forces, and actuate the mechanism, so as to transfer the forces through the mechanism and to the clamp and electrode,
said clamp being connected to a clamp swing arm,
said electrode being connected to a weld swing arm,
said swing arms sharing an axis of rotation and being concurrently rotatable between an initial disengaged position and a workpiece engaged position,
said mechanism, clamp and electrode being cooperatively configured such that the clamp engages the workpieces prior to the electrode engages the workpieces.

20. A method of clamping and welding a plurality of workpieces in a predetermined assembly configuration, and reducing assembly cell congestion, said method including the steps of:
a. determining at least one datum location for clamping the workpieces, so as to minimize assembly deformation during clamping and welding;
b. securing the workpieces in the assembly configuration, and securing a clamping and welding system having a single drive mechanism in relation to the workpieces;
c. applying pressure to the workpieces at the datum location by actuating the drive mechanism of the system, so as to clamp and retain the workpieces in the assembly configuration; and
d. passing an electric current through and applying pressure to the workpieces at a second location substantially adjacent the first location, so as to form a weld at the second location also by actuating the drive mechanism of the system.
